(19) United States
(12) Patent Application Publication
(10) Pub. No.: US 2012/0316896 A1
(43) Pub. Date: Dec. 13, 2012

(54) PERSONAL ADVISOR SYSTEM USING DATA-CAPABLE BAND

(75) Inventors: Hosain Sadequr Rahman, San Francisco, CA (US); Richard Lee Drysdale, Santa Cruz, CA (US); Michael Edward Smith Luna, San Jose, CA (US); Scott Fullam, Palo Alto, CA (US); Travis Austin Bogard, San Francisco, CA (US); Jeremiah Robison, San Francisco, CA (US); Max Everett Utter, II, San Francisco, CA (US); Thomas Alan Donaldson, London (GB); Raymond A. Martino, Los Gatos, CA (US)

(73) Assignee: AliphCom, San Francisco, CA (US)

(21) Appl. No.: 13/181,511

(22) Filed: Jul. 12, 2011

Related U.S. Application Data
(63) Continuation-in-part of application No. 13/180,000, filed on Jul. 11, 2011.
Application No. 13/180,000 is a continuation-in-part of application No. 13/180,320, filed on Jul. 11, 2011.
Application No. 13/180,320 is a continuation-in-part of application No. 13/158,372, filed on Jun. 10, 2011.
Application No. 13/158,372 is a continuation-in-part of application No. 13/158,416, filed on Jun. 11, 2011.
(60) Provisional application No. 61/495,995, filed on Jun. 11, 2011.
(60) Provisional application No. 61/495,994, filed on Jun. 11, 2011.
(60) Provisional application No. 61/495,997, filed on Jun. 11, 2011.
(60) Provisional application No. 61/495,996, filed on Jun. 11, 2011.

(51) Int. Cl. G06Q 50/00

(52) U.S. Cl. 705/3

(57) ABSTRACT

A personal advisor system using a data-capable band including a personal advisor distributed application comprising a feedback engine configured to process user activity data from a source device, the source device comprising at least one data-capable band; a recommendation module configured to generate a wellness recommendation using the user activity data; a personal offer module configured to generate a personal wellness offer using the user activity data; and a notification module configured to generate a feedback notification comprising one or more of the wellness recommendation and the personal wellness offer. The feedback engine is operable to communicate the feedback notification to the source device, if the source device is active, or to a non-source device upon request from the non-source device.

### CROSS-REFERENCE TO RELATED APPLICATIONS

This application is a continuation-in-part U.S. non-provisional patent application of U.S. non-provisional patent application that claims the benefit of U.S. patent application Ser. No. 13/180,000, filed Jul. 11, 2011, entitled “Data-Capable Band for Medical Diagnosis, Monitoring, and Treatment,” U.S. patent application Ser. No. 13/180,320, filed Jul. 11, 2011, entitled “Power Management in a Data-Capable Strapband,” U.S. patent application Ser. No. 13/158,372, filed Jun. 10, 2011, and entitled “Component Protective Overmolding,” U.S. patent application Ser. No. 13/158,416, filed Jun. 11, 2011, and entitled “Component Protective Overmolding,” and claims the benefit of U.S. Provisional Patent Application No. 61/495,995, filed Jun. 11, 2011, and entitled “Data-Capable Strapband,” U.S. Provisional Patent Application No. 61,495,994, filed Jun. 11, 2011, and entitled “Data-Capable Strapband,” U.S. Provisional Patent Application No. 61/495,997, filed Jun. 11, 2011, and entitled “Data-Capable Strapband,” and U.S. Provisional Patent Application No. 61/495,996, filed Jun. 11, 2011, and entitled “Data-Capable Strapband,” all of which are herein incorporated by reference for all purposes.

### FIELD

The present invention relates generally to electrical and electronic hardware, computer software, wired and wireless network communications, and computing devices. More specifically, techniques for a personal advisor system using a data-capable personal worn or carried device, are described.

### BACKGROUND

With the advent of greater computing capabilities in smaller personal and/or portable form factors and an increasing number of applications (i.e., computer and Internet software or programs) for different uses, consumers (i.e., users) have access to large amounts of personal data. Information and data are often readily available, but poorly captured using conventional data capture devices. Conventional devices typically lack capabilities that can capture, analyze, communicate, or use data in a contextually-meaningful, comprehensive, and efficient manner. Further, conventional solutions are often limited to specific individual purposes or uses, demanding that users invest in multiple devices in order to perform different activities (e.g., a sports watch for tracking time and distance, a GPS receiver for monitoring a hike or run, a cyclometer for gathering cycling data, and others). Although a wide range of data and information is available, conventional devices and applications fail to provide effective solutions that comprehensively capture data for a given user across numerous disparate activities.

Some conventional solutions combine a small number of discrete functions. Functionality for data capture, processing, storage, or communication in conventional devices such as a watch or timer with a heart rate monitor or global positioning system (“GPS”) receiver are available conventionally, but are expensive to manufacture and purchase. Other conventional solutions for combining personal data capture facilities often present numerous design and manufacturing problems such as size restrictions, specialized materials requirements, lowered tolerances for defects such as pits or holes in coverings for water-resistant or waterproof devices, unreliability, higher failure rates, increased manufacturing time, and expense. Subsequently, conventional devices such as fitness watches, heart rate monitors, GPS-enabled fitness monitors, health monitors (e.g., diabetic blood sugar testing units), digital voice recorders, pedometers, altimeters, and other conventional personal data capture devices are generally manufactured for conditions that occur in a single or small groupings of activities. Problematically, though, conventional devices do not provide effective solutions to users in terms of providing a comprehensive view of one's overall health or wellness as a result of a combined analysis of data gathered. Conventional devices also do not provide effective feedback (e.g., advice, recommendations, etc.) based on a comprehensive view of one's overall health or wellness, as may be developed using a combination of data gathering techniques. This is a limiting aspect of the commercial attraction of the various types of conventional devices listed above.

Generally, if the number of activities performed by conventional personal data capture devices increases, there is a corresponding rise in design and manufacturing requirements that results in significant consumer expense, which eventually becomes prohibitive to both investment and commercialization. Further, conventional manufacturing techniques are often limited and ineffective at meeting increased requirements to protect sensitive hardware, circuitry, and other components that are susceptible to damage, but which are required to perform various personal data capture activities. As a conventional example, sensitive electronic components such as printed circuit board assemblies (“PCBA”), sensors, and computer memory (hereafter “memory”) can be significantly damaged or destroyed during manufacturing processes where overmoldings or layering of protective material occurs using techniques such as injection molding, cold molding, and others. Damaged or destroyed items subsequently raises the cost of goods sold and can deter not only investment and commercialization, but also innovation in data capture and analysis technologies, which are highly compelling fields of opportunity.

Thus, what is needed is a solution for data capture devices without the limitations of conventional techniques.

### BRIEF DESCRIPTION OF THE DRAWINGS

Various embodiments or examples of the invention are disclosed in the following detailed description and the accompanying drawings:

FIG. 1 illustrates an exemplary data-capable band system;

FIG. 2 illustrates a block diagram of an exemplary data-capable band;

FIG. 3 illustrates sensors for use with an exemplary data-capable band;

FIG. 4 illustrates an application architecture for an exemplary data-capable band;

FIG. 5A illustrates representative data types for use with an exemplary data-capable band;

FIG. 5B illustrates representative data types for use with an exemplary data-capable band in fitness-related activities;

FIG. 5C illustrates representative data types for use with an exemplary data-capable band in sleep management activities;

FIG. 5D illustrates representative data types for use with an exemplary data-capable band in medical-related activities;

FIG. 5E illustrates representative data types for use with an exemplary data-capable band in social media/networking-related activities;

FIGS. 6A-6B illustrate exemplary communications device systems implemented with multiple exemplary data-capable bands;

FIG. 7 illustrates an exemplary distributed personal advisor system implemented with multiple sensory, computing and communications devices, and a distributed application;

FIG. 8 illustrates an exemplary process for providing feedback notifications based upon activity data;

FIGS. 9A-9B illustrate exemplary wireframes of exemplary webpages including features that may be used in a personal advisor system; and

FIG. 10 illustrates an exemplary computer system suitable for implementation of a distributed personal advisor application and use with a data-capable band.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

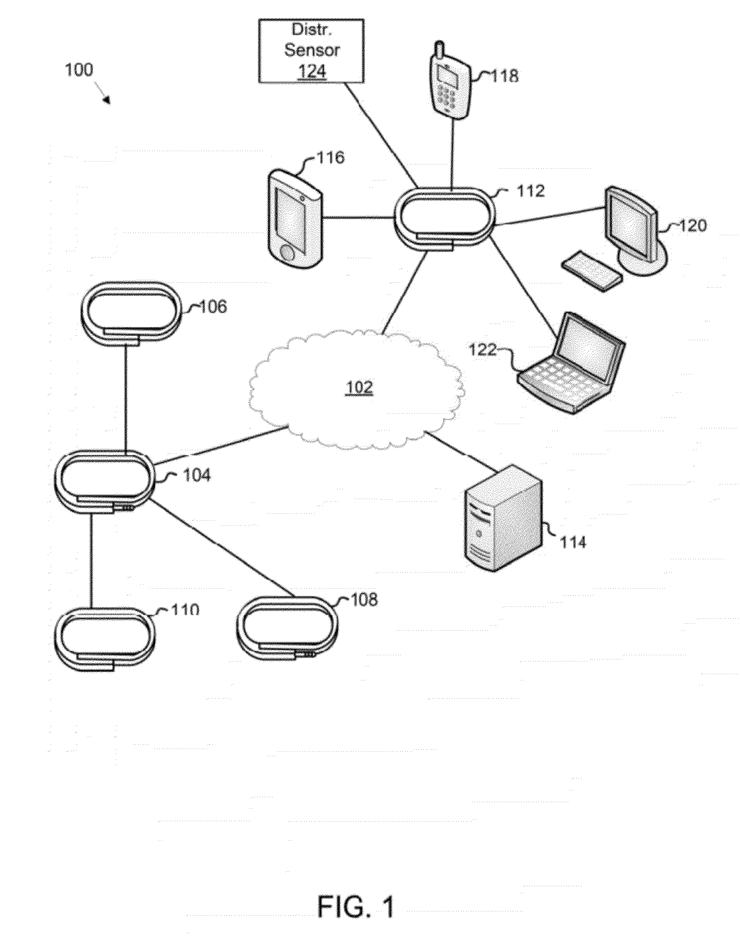

FIG. 1 illustrates an exemplary data-capable band system. Here, system 100 includes network 102, bands 104-112, server 114, mobile computing device 116, mobile communications device 118, computer 120, laptop 122, and distributed sensor 124. Bands 104-112 may be implemented as data-capable device that may be worn as a strap or band around an arm, leg, ankle, or other bodily appendage or feature. In other examples, bands 104-112 may be attached directly or indirectly to other items, organic or inorganic, animate, or static. In still other examples, bands 104-112 may be used differently.

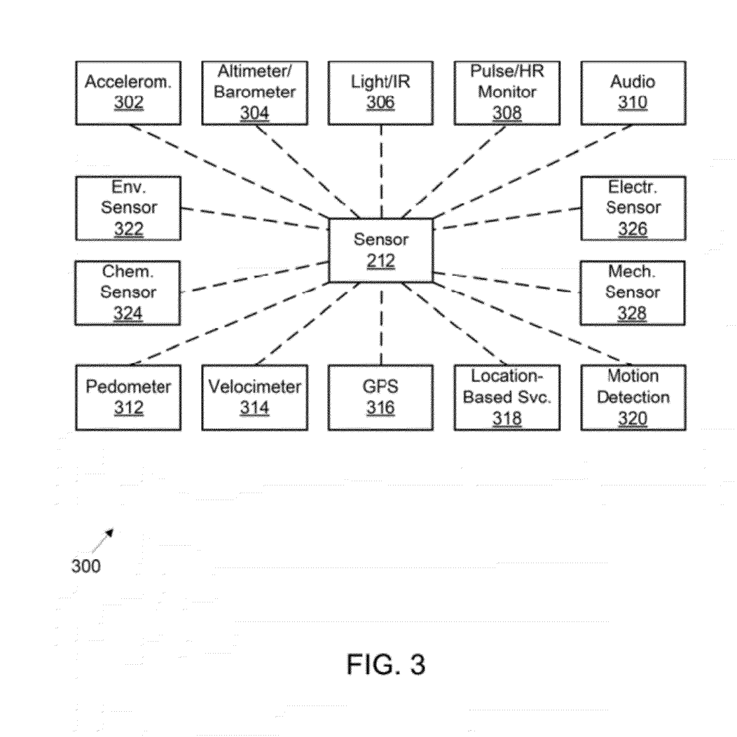

As described above, bands 104-112 may be implemented as wearable personal data or data capture devices (e.g., data-capable devices) that are worn by a user around a wrist, ankle, arm, ear, or other appendage, or attached to the body or affixed to clothing. One or more facilities, sensing elements, or sensors, both active and passive, may be implemented as part of bands 104-112 in order to capture various types of data from different sources. Temperature, environmental, temporal, motion, electronic, electrical, chemical, or other types of sensors (including those described below in connection with FIG. 3) may be used in order to gather varying amounts of data, which may be configurable by a user, locally (e.g., using user interface facilities such as buttons, switches, motion-activated/detected command structures (e.g., accelerometer-gathered data from user-initiated motion of bands 104-112), and others) or remotely (e.g., entering rules or parameters in a website or graphical user interface (“GUI”) that may be used to modify control systems or signals in firmware, circuitry, hardware, and software implemented (i.e., installed) on bands 104-112). Bands 104-112 may also be implemented as data-capable devices that are configured for data communication using various types of communications infrastructure and media, as described in greater detail below. Bands 104-112 may also be wearable, personal, non-intrusive, lightweight devices that arc configured to gather large amounts of personally relevant data that can be used to improve user health, fitness levels, medical conditions, athletic performance, sleeping physiology, and physiological conditions, or used as a sensory-based user interface (“UI”) to signal social-related notifications specifying the state of the user through vibration, heat, lights or other sensory based notifications. For example, a social-related notification signal indicating a user is on-line can be transmitted to a recipient, who in turn, receives the notification as, for instance, a vibration. In some examples, the aesthetic appearance of bands 104-112 may be customizable, or varied according to various aesthetic designs, that may be worn by a user around a wrist, ankle, arm, ear, or other appendage, or attached to the body or affixed to clothing, or carried. For example, bands 104-112 may be configured to be worn as jewelry or accessories, with different colors, patterns, designs, lettering, engraving or other aesthetic details and features, that also function as data and communications capable devices.

Using data gathered by bands 104-112, applications may be used to perform various analyses and evaluations that can generate information as to a person's physical (e.g., healthy, sick, weakened, or other states, or activity level), emotional, or mental state (e.g., an elevated body temperature or heart rate may indicate stress, a lowered heart rate and skin temperature, or reduced movement (e.g., excessive sleeping), may indicate physiological depression caused by exertion or other factors, chemical data gathered from evaluating outgassing from the skin's surface may be analyzed to determine whether a person's diet is balanced or if various nutrients are lacking, salinity detectors may be evaluated to determine if high, lower, or proper blood sugar levels are present for diabetes management, and others). Generally, bands 104-112 may be configured to gather from sensors locally and remotely.

As an example, band 104 may capture (i.e., record, store, communicate (i.e., send or receive), process, or the like) data from various sources (i.e., sensors that are organic (i.e., installed, integrated, or otherwise implemented with band 104) or distributed (e.g., microphones on mobile computing device 116, mobile communications device 118, computer 120, laptop 122, distributed sensor 124, global positioning system (“GPS”) satellites, or others, without limitation)) and exchange data with one or more of bands 106-112, server 114, mobile computing device 116, mobile communications device 118, computer 120, laptop 122, and distributed sensor 124. As shown here, a local sensor may be one that is incorporated, integrated, or otherwise implemented with bands 104-112. A remote or distributed sensor (e.g., mobile computing device 116, mobile communications device 118, computer 120, laptop 122, or, generally, distributed sensor 124) may be sensors that can be accessed, controlled, or otherwise used by bands 104-112. For example, band 112 may be configured to control devices that are also controlled by a given user (e.g., mobile computing device 116, mobile communications device 118, computer 120, laptop 122, and distributed sensor 124). For example, a microphone in mobile communications device 118 may be used to detect, for example, ambient audio data that is used to help identify a person's location, or an ear clip (e.g., a headset as described below) affixed to an ear may be used to record pulse or blood oxygen saturation levels. Additionally, a sensor implemented with a screen on mobile computing device 116 may be used to read a user's temperature or obtain a biometric signature while a user is interacting with data. A further example may include using data that is observed on computer 120 or laptop 122 that provides information as to a user's online behavior and the type of content that she is viewing, which may be used by bands 104-112. Regardless of the type or location of sensor used, data may be transferred to bands 104-112 by using, for example, an analog audio jack, digital adapter (e.g., USB, mini-USB), or other, without limitation, plug, or other type of connector that may be used to physically couple bands 104-112 to another device or system for transferring data and, in some examples, to provide power to recharge a battery (not shown). Alternatively, a wireless data communication interface or facility (e.g., a wireless radio that is configured to communicate data from bands 104-112 using one or more data communication protocols (e.g., IEEE 802.11a/b/g/n (WiFi), WiMax, ANT™, ZigBee®, Bluetooth®, Near Field Communications (“NFC”), and others)) may be used to receive or transfer data. Further, bands 104-112 may be configured to analyze, evaluate, modify, or otherwise use data gathered, either directly or indirectly.

In some examples, bands 104-112 may be configured to share data with each other or with an intermediary facility, such as a database, website, web service, or the like, which may be implemented by server 114. In some embodiments, server 114 can be operated by a third party providing, for example, social media-related services. Bands 104-112 and other related devices may exchange data with each other directly, or bands 104-112 may exchange data via a third party server, such as a third party like Facebook®, to provide social-media related services. Examples of other third party servers include those implemented by social networking services, including, but not limited to, services such as Yahoo! IM™, GTalk™, MSN Messenger™, Twitter® and other private or public social networks. The exchanged data may include personal physiological data and data derived from sensory-based user interfaces (“UI”). Server 114, in some examples, may be implemented using one or more processor-based computing devices or networks, including computing clouds, storage area networks (“SAN”), or the like. As shown, bands 104-112 may be used as a personal data or area network (e.g., “PDN” or “PAN”) in which data relevant to a given user or band (e.g., one or more of bands 104-112) may be shared. As shown here, bands 104 and 112 may be configured to exchange data with each other over network 102 or indirectly using server 114. Users of bands 104 and 112 may direct a web browser hosted on a computer (e.g., computer 120, laptop 122, or the like) in order to access, view, modify, or perform other operations with data captured by bands 104 and 112. For example, two runners using bands 104 and 112 may be geographically remote (e.g., users are not geographically in close proximity such that bands being used by each user may be in direct data communication), but wish to share data regarding their race times (pre, post, or in-race), personal records (i.e., “PR”), target split times, results, performance characteristics (e.g., target heart rate, target VO₂ max, and others), and other information. If both runners (i.e., bands 104 and 112) are engaged in a race on the same day, data can be gathered for comparative analysis and other uses. Further, data can be shared in substantially real-time (taking into account any latencies incurred by data transfer rates, network topologies, or other data network factors) as well as uploaded after a given activity or event has been performed. In other words, data can be captured by the user as it is worn and configured to transfer data using, for example, a wireless network connection (e.g., a wireless network interface card, wireless local area network (“LAN”) card, cell phone, or the like). Data may also be shared in a temporally asynchronous manner in which a wired data connection (e.g., an analog audio plug (and associated software or firmware) configured to transfer digitally encoded data to encoded audio data that may be transferred between bands 104-112 and a plug configured to receive, encode/decode, and process data exchanged) may be used to transfer data from one or more bands 104-112 to various destinations (e.g., another of bands 104-112, server 114, mobile computing device 116, mobile communications device 118, computer 120, laptop 122, and distributed sensor 124). Bands 104-112 may be implemented with various types of wired and/or wireless communication facilities and are not intended to be limited to any specific technology. For example, data may be transferred from bands 104-112 using an analog audio plug (e.g., TRRS, TRS, or others). In other examples, wireless communication facilities using various types of data communication protocols (e.g., WiFi, Bluetooth®, ZigBee®, ANT™, and others) may be implemented as part of bands 104-112, which may include circuitry, firmware, hardware, radios, antennas, processors, microprocessors, memories, or other electrical, electronic, mechanical, or physical elements configured to enable data communication capabilities of various types and characteristics.

As data-capable devices, bands 104-112 may be configured to collect data from a wide range of sources, including onboard (not shown) and distributed sensors (e.g., server 114, mobile computing device 116, mobile communications device 118, computer 120, laptop 122, and distributed sensor 124) or other bands. Some or all data captured may be personal, sensitive, or confidential and various techniques for providing secure storage and access may be implemented. For example, various types of security protocols and algorithms may be used to encode data stored or accessed by bands 104-112. Examples of security protocols and algorithms include authentication, encryption, encoding, private and public key infrastructure, passwords, checksums, hash codes and hash functions (e.g., SHA, SHA-1, MD-5, and the like), or others may be used to prevent undesired access to data captured by bands 104-112. In other examples, data security for bands 104-112 may be implemented differently.

Bands 104-112 may be used as personal wearable, data capture devices that, when worn, are configured to identify a specific, individual user. By evaluating captured data such as motion data from an accelerometer, biometric data such as heart rate, skin galvanic response, and other biometric data, and using long-term analysis techniques (e.g., software packages or modules of any type, without limitation), a user may have a unique pattern of behavior or motion and/or biometric responses that can be used as a signature for identification. For example, bands 104-112 may gather data regarding an individual person's gait or other unique biometric, physiological or behavioral characteristics. Using, for example, distributed sensor 124, a biometric signature (e.g., fingerprint, retinal or iris vascular pattern, or others) may be gathered and transmitted to bands 104-112 that, when combined with other data, determines that a given user has been properly identified and, as such, authenticated. When bands 104-112 are worn, a user may be identified and authenticated to enable a variety of other functions such as accessing or modifying data, enabling wired or wireless data transmission facilities (i.e., allowing the transfer of data from bands 104-1 12), modifying functionality or functions of bands 104-112, authenticating financial transactions using stored data and information (e.g., credit card, PIN, card security numbers, and the like), running applications that allow for various operations to be performed (e.g., controlling physical security and access by transmitting a security code to a reader that, when authenticated, unlocks a door by turning off current to an electromagnetic lock, and others), and others. Different functions and operations beyond those described may be performed using bands 104-112, which can act as secure, personal, wearable, data-capable devices. The number, type, function, configuration, specifications, structure, or other features of system 100 and the above-described elements may be varied and are not limited to the examples provided.

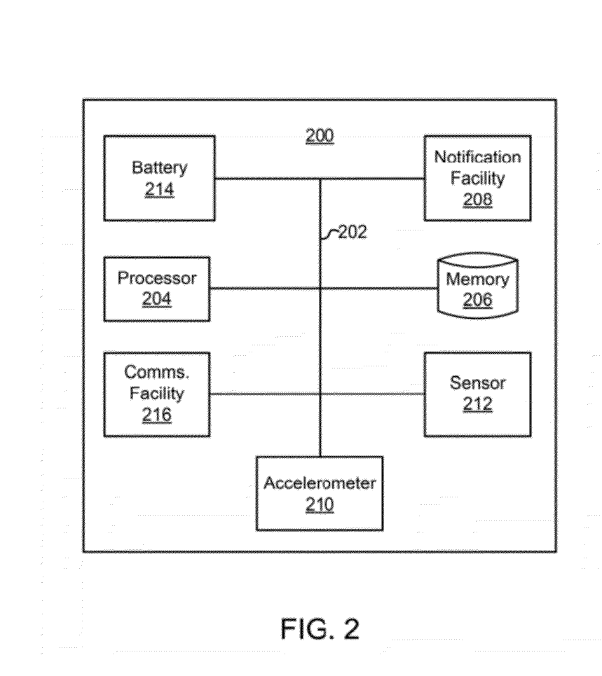

FIG. 2 illustrates a block diagram of an exemplary data-capable band. Here, band 200 includes bus 202, processor 204, memory 206, notification facility 208, accelerometer 210, sensor 212, battery 214, and communications facility 216. In some examples, the quantity, type, function, structure, and configuration of band 200 and the elements (e.g., bus 202, processor 204, memory 206, notification facility 208, accelerometer 210, sensor 212, battery 214, and communications facility 216) shown may be varied and are not limited to the examples provided. As shown, processor 204 may be implemented as logic to provide control functions and signals to memory 206, notification facility 208, accelerometer 210, sensor 212, battery 214, and communications facility 216. Processor 204 may be implemented using any type of processor or microprocessor suitable for packaging within bands 104-112 (FIG. 1). Various types of microprocessors may be used to provide data processing capabilities for band 200 and are not limited to any specific type or capability. For example, a MSP430F5528-type microprocessor manufactured by Texas Instruments of Dallas, Texas may be configured for data communication using audio tones and enabling the use of an audio plug-and-jack system (e.g., TRRS, TRS, or others) for transferring data captured by band 200. Further, different processors may be desired if other functionality (e.g., the type and number of sensors (e.g., sensor 212)) are varied. Data processed by processor 204 may be stored using, for example, memory 206.

In some examples, memory 206 may be implemented using various types of data storage technologies and standards, including, without limitation, read-only memory (“ROM”), random access memory (“RAM”), dynamic random access memory (“DRAM”), static random access memory (“SRAM”), static/dynamic random access memory (“SDRAM”), magnetic random access memory (“MRAM”), solid state, two and three-dimensional memories, Flash®, and others. Memory 206 may also be implemented using one or more partitions that arc configured for multiple types of data storage technologies to allow for non-modifiable (i.e., by a user) software to be installed (e.g., firmware installed on ROM) while also providing for storage of captured data and applications using, for example, RAM. Once captured and/or stored in memory 206, data may be subjected to various operations performed by other elements of band 200.

Notification facility 208, in some examples, may be implemented to provide vibratory energy, audio or visual signals, communicated through band 200. As used herein, “facility” refers to any, some, or all of the features and structures that are used to implement a given set of functions. In some examples, the vibratory energy may be implemented using a motor or other mechanical structure. In some examples, the audio signal may be a tone or other audio cue, or it may be implemented using different sounds for different purposes. The audio signals may be emitted directly using notification facility 208, or indirectly by transmission via communications facility 216 to other audio-capable devices (e.g., headphones (not shown), a headset (as described below with regard to FIG. 12), mobile computing device 116, mobile communications device 118, computer 120, laptop 122, distributed sensor 124, etc.). In some examples, the visual signal may be implemented using any available display technology, such as lights, light-emitting diodes (LEDs), interferometric modulator display (IMOD), electrophoretic ink (E Ink), organic light-emitting diode (OLED), or other display technologies. As an example, an application stored on memory 206 may be configured to monitor a clock signal from processor 204 in order to provide timekeeping functions to band 200. For example, if an alarm is set for a desired time, notification facility 208 may be used to provide a vibration or an audio tone, or a series of vibrations or audio tones, when the desired time occurs. As another example, notification facility 208 may be coupled to a framework (not shown) or other structure that is used to translate or communicate vibratory energy throughout the physical structure of band 200. In other examples, notification facility 208 may be implemented differently.

Power may be stored in battery 214, which may be implemented as a battery, battery module, power management module, or the like. Power may also be gathered from local power sources such as solar panels, thermo-electric generators, and kinetic energy generators, among others-that are alternatives power sources to external power for a battery. These additional sources can either power the system directly or can charge a battery, which, in turn, is used to power the system (e.g., of a band). In other words, battery 214 may include a rechargeable, expendable, replaceable, or other type of battery, but also circuitry, hardware, or software that may be used in connection with in lieu of processor 204 in order to provide power management, charge/recharging, sleep, or other functions. Further, battery 214 may be implemented using various types of battery technologies, including Lithium Ion (“LI”), Nickel Metal Hydride (“NiMH”), or others, without limitation. Power drawn as electrical current may be distributed from battery via bus 202, the latter of which may be implemented as deposited or formed circuitry or using other forms of circuits or cabling, including flexible circuitry. Electrical current distributed from battery 204 and managed by processor 204 may be used by one or more of memory 206, notification facility 208, accelerometer 210, sensor 212, or communications facility 216.

As shown, various sensors may be used as input sources for data captured by band 200. For example, accelerometer 210 may be used to gather data measured across one, two, or three axes of motion. In addition to accelerometer 210, other sensors (i.e., sensor 212) may be implemented to provide temperature, environmental, physical, chemical, electrical, or other types of sensed inputs. As presented here, sensor 212 may include one or multiple sensors and is not intended to be limiting as to the quantity or type of sensor implemented. Data captured by band 200 using accelerometer 210 and sensor 212 or data requested from another source (i.e., outside of band 200) may also be exchanged, transferred, or otherwise communicated using communications facility 216. For example, communications facility 216 may include a wireless radio, control circuit or logic, antenna, transceiver, receiver, transmitter, resistors, diodes, transistors, or other elements that are used to transmit and receive data from band 200. In some examples, communications facility 216 may be implemented to provide a “wired” data communication capability such as an analog or digital attachment, plug, jack, or the like to allow for data to be transferred. In other examples, communications facility 216 may be implemented to provide a wireless data communication capability to transmit digitally encoded data across one or more frequencies using various types of data communication protocols, without limitation. In still other examples, band 200 and the above-described elements may be varied in function, structure, configuration, or implementation and arc not limited to those shown and described.

FIG. 3 illustrates sensors for use with an exemplary data-capable band. Sensor 212 may be implemented using various types of sensors, some of which are shown. Like-numbered and named elements may describe the same or substantially similar element as those shown in other descriptions. Here, sensor 212 (FIG. 2) may be implemented as accelerometer 302, altimeter/barometer 304, light/infrared (“IR”) sensor 306, pulse/heart rate (“HR”) monitor 308, audio sensor (e.g., microphone, transducer, or others) 310, pedometer 312, velocimeter 314, GPS receiver 316, location-based service sensor (e.g., sensor for determining location within a cellular or micro-cellular network, which may or may not use GPS or other satellite constellations for fixing a position) 318, motion detection sensor 320, environmental sensor 322, chemical sensor 324, electrical sensor 326, or mechanical sensor 328.

As shown, accelerometer 302 may be used to capture data associated with motion detection along 1, 2, or 3-axes of measurement, without limitation to any specific type of specification of sensor. Accelerometer 302 may also be implemented to measure various types of user motion and may be configured based on the type of sensor, firmware, software, hardware, or circuitry used. As another example, altimeter/barometer 304 may be used to measure environment pressure, atmospheric or otherwise, and is not limited to any specification or type of pressure-reading device. In some examples, altimeter/barometer 304 may be an altimeter, a barometer, or a combination thereof. For example, altimeter/barometer 304 may be implemented as an altimeter for measuring above ground level (“AGL”) pressure in band 200, which has been configured for use by naval or military aviators. As another example, altimeter/barometer 304 may be implemented as a barometer for reading atmospheric pressure for marine-based applications. In other examples, altimeter/barometer 304 may be implemented differently.

Other types of sensors that may be used to measure light or photonic conditions include light/IR sensor 306, motion detection sensor 320, and environmental sensor 322, the latter of which may include any type of sensor for capturing data associated with environmental conditions beyond light. Further, motion detection sensor 320 may be configured to detect motion using a variety of techniques and technologies, including, but not limited to comparative or differential light analysis (e.g., comparing foreground and background lighting), sound monitoring, or others. Audio sensor 310 may be implemented using any type of device configured to record or capture sound.

In some examples, pedometer 312 may be implemented using devices to measure various types of data associated with pedestrian-oriented activities such as running or walking. Footstrikes, stride length, stride length or interval, time, and other data may be measured. Velocimeter 314 may be implemented, in some examples, to measure velocity (e.g., speed and directional vectors) without limitation to any particular activity. Further, additional sensors that may be used as sensor 212 include those configured to identify or obtain location-based data. For example, GPS receiver 316 may be used to obtain coordinates of the geographic location of band 200 using, for example, various types of signals transmitted by civilian and/or military satellite constellations in low, medium, or high earth orbit (e.g., “LEO,” “MEO,” or “GEO”). In other examples, differential GPS algorithms may also be implemented with GPS receiver 316, which may be used to generate more precise or accurate coordinates. Still further, location-based services sensor 318 may be implemented to obtain location-based data including, but not limited to location, nearby services or items of interest, and the like. As an example, location-based services sensor 318 may be configured to detect an electronic signal, encoded or otherwise, that provides information regarding a physical locale as band 200 passes. The electronic signal may include, in some examples, encoded data regarding the location and information associated therewith. Electrical sensor 326 and mechanical sensor 328 may be configured to include other types (e.g., haptic, kinetic, piezoelectric, piezomechanical, pressure, touch, thermal, and others) of sensors for data input to band 200, without limitation. Other types of sensors apart from those shown may also be used, including magnetic flux sensors such as solid-state compasses and the like, including gyroscopic sensors. While the present illustration provides numerous examples of types of sensors that may be used with band 200 (FIG. 2), others not shown or described may be implemented with or as a substitute for any sensor shown or described.

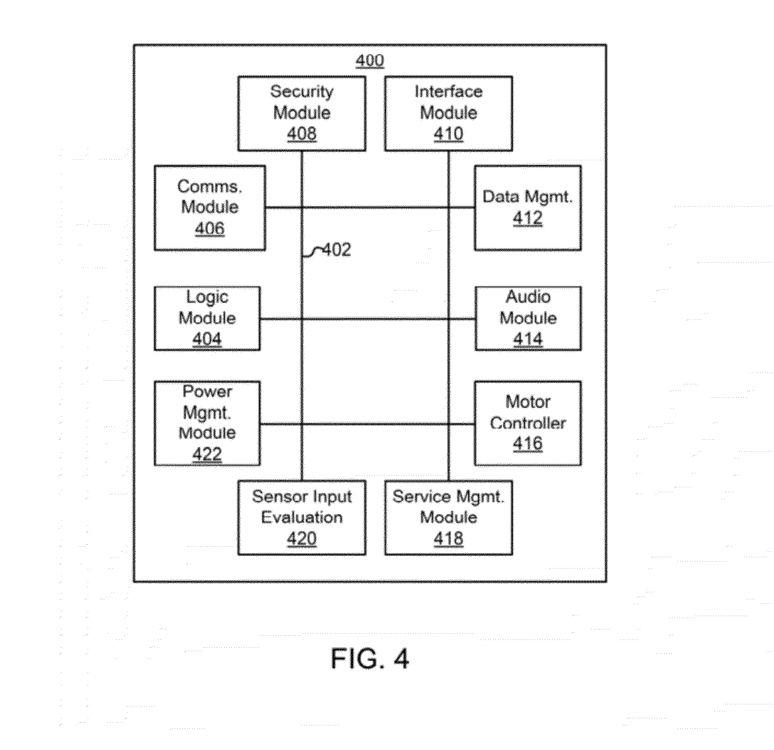

FIG. 4 illustrates an application architecture for an exemplary data-capable band. Here, application architecture 400 includes bus 402, logic module 404, communications module 406, security module 408, interface module 410, data management 412, audio module 414, motor controller 416, service management module 418, sensor input evaluation module 420, and power management module 422. In some examples, application architecture 400 and the above-listed elements (e.g., bus 402, logic module 404, communications module 406, security module 408, interface module 410, data management 412, audio module 414, motor controller 416, service management module 418, sensor input evaluation module 420, and power management module 422) may be implemented as software using various computer programming and formatting languages such as Java, C++, C, and others. As shown here, logic module 404 may be firmware or application software that is installed in memory 206 (FIG. 2) and executed by processor 204 (FIG. 2). Included with logic module 404 may be program instructions or code (e.g., source, object, binary executables, or others) that, when initiated, called, or instantiated, perform various functions.

For example, logic module 404 may be configured to send control signals to communications module 406 in order to transfer, transmit, or receive data stored in memory 206, the latter of which may be managed by a database management system (“DBMS”) or utility in data management module 412. As another example, security module 408 may be controlled by logic module 404 to provide encoding, decoding, encryption, authentication, or other functions to band 200 (FIG. 2). Alternatively, security module 408 may also be implemented as an application that, using data captured from various sensors and stored in memory 206 (and accessed by data management module 412) may be used to provide identification functions that enable band 200 to passively identify a user or wearer of band 200. Still further, various types of security software and applications may be used and are not limited to those shown and described.

Interface module 410, in some examples, may be used to manage user interface controls such as switches, buttons, or other types of controls that enable a user to manage various functions of band 200. For example, a 4-position switch may be turned to a given position that is interpreted by interface module 410 to determine the proper signal or feedback to send to logic module 404 in order to generate a particular result. In other examples, a button (not shown) may be depressed that allows a user to trigger or initiate certain actions by sending another signal to logic module 404. Still further, interface module 410 may be used to interpret data from, for example, accelerometer 210 (FIG. 2) to identify specific movement or motion that initiates or triggers a given response. In other examples, interface module 410 may be used to manage different types of displays (e.g., LED, IMOD, E Ink, OLED, etc.). In other examples, interface module 410 may be implemented differently in function, structure, or configuration and is not limited to those shown and described.

As shown, audio module 414 may be configured to manage encoded or unencoded data gathered from various types of audio sensors. In some examples, audio module 414 may include one or more codecs that are used to encode or decode various types of audio waveforms. For example, analog audio input may be encoded by audio module 414 and, once encoded, sent as a signal or collection of data packets, messages, segments, frames, or the like to logic module 404 for transmission via communications module 406. In other examples, audio module 414 may be implemented differently in function, structure, configuration, or implementation and is not limited to those shown and described. Other elements that may be used by band 200 include motor controller 416, which may be firmware or an application to control a motor or other vibratory energy source (e.g., notification facility 208 (FIG. 2)). Power used for band 200 may be drawn from battery 214 (FIG. 2) and managed by power management module 422, which may be firmware or an application used to manage, with or without user input, how power is consumer, conserved, or otherwise used by band 200 and the above-described elements, including one or more sensors (e.g., sensor 212 (FIG. 2), sensors 302-328 (FIG. 3)). With regard to data captured, sensor input evaluation module 420 may be a software engine or module that is used to evaluate and analyze data received from one or more inputs (e.g., sensors 302-328) to band 200. When received, data may be analyzed by sensor input evaluation module 420, which may include custom or “off-the-shelf” analytics packages that are configured to provide application-specific analysis of data to determine trends, patterns, and other useful information. In other examples, sensor input module 420 may also include firmware or software that enables the generation of various types and formats of reports for presenting data and any analysis performed thereupon.

Another element of application architecture 400 that may be included is service management module 418. In some examples, service management module 418 may be firmware, software, or an application that is configured to manage various aspects and operations associated with executing software-related instructions for band 200. For example, libraries or classes that are used by software or applications on band 200 may be served from an online or networked source. Service management module 418 may be implemented to manage how and when these services are invoked in order to ensure that desired applications are executed properly within application architecture 400. As discrete sets, collections, or groupings of functions, services used by band 200 for various purposes ranging from communications to operating systems to call or document libraries may be managed by service management module 418. Alternatively, service management module 418 may be implemented differently and is not limited to the examples provided herein. Further, application architecture 400 is an example of a software/system/application-level architecture that may be used to implement various software-related aspects of band 200 and may be varied in the quantity, type, configuration, function, structure, or type of programming or formatting languages used, without limitation to any given example.

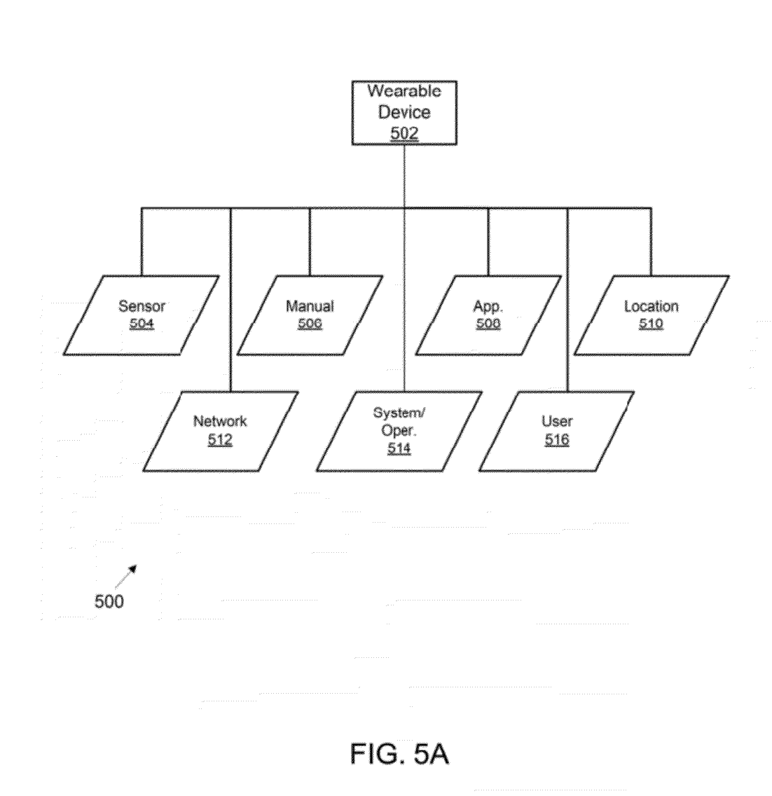

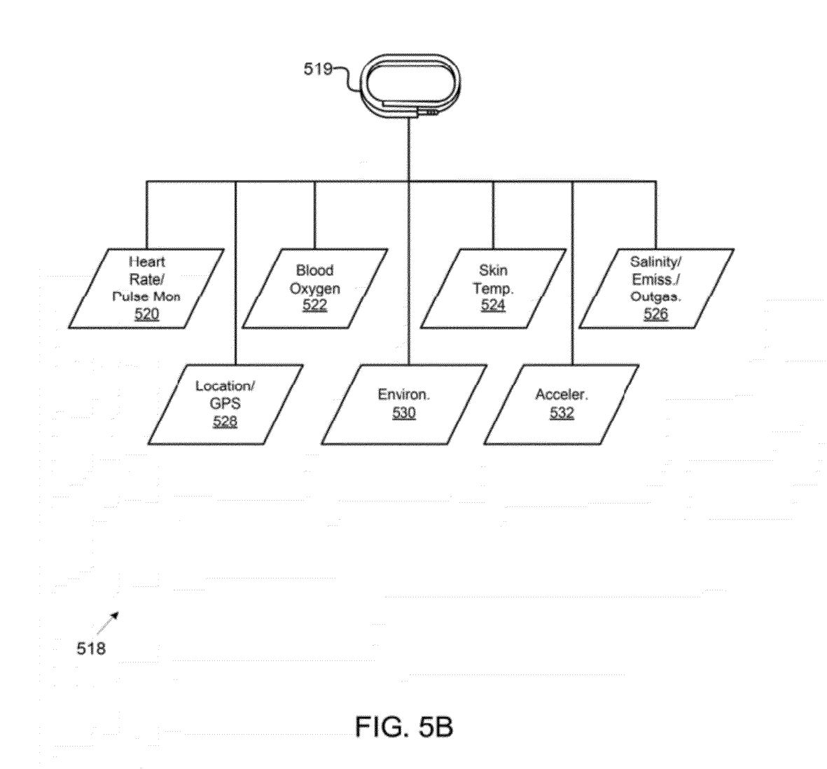

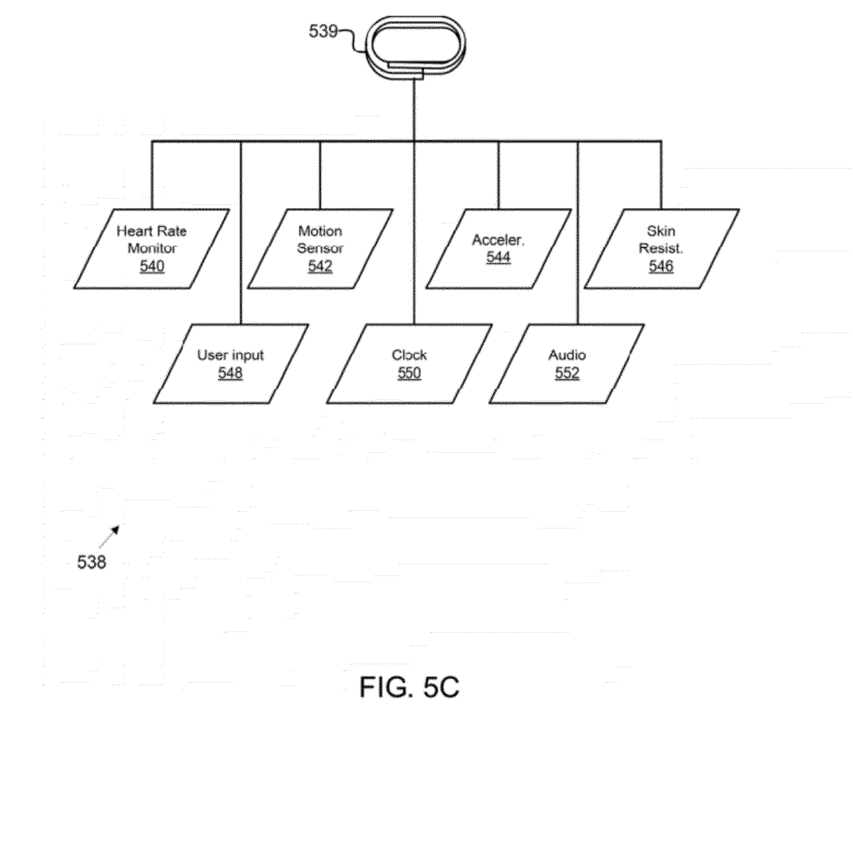

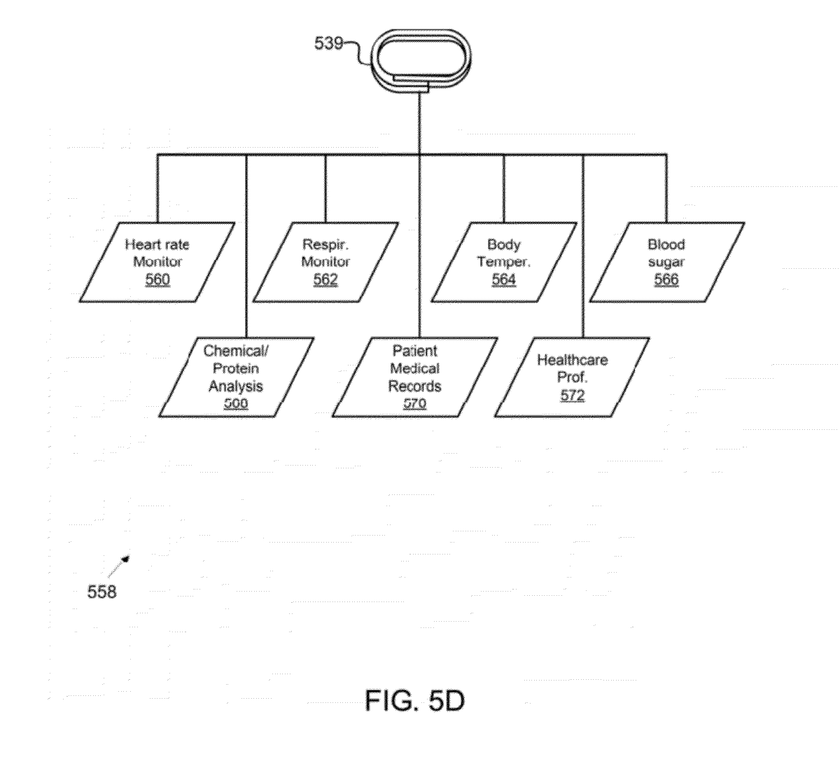

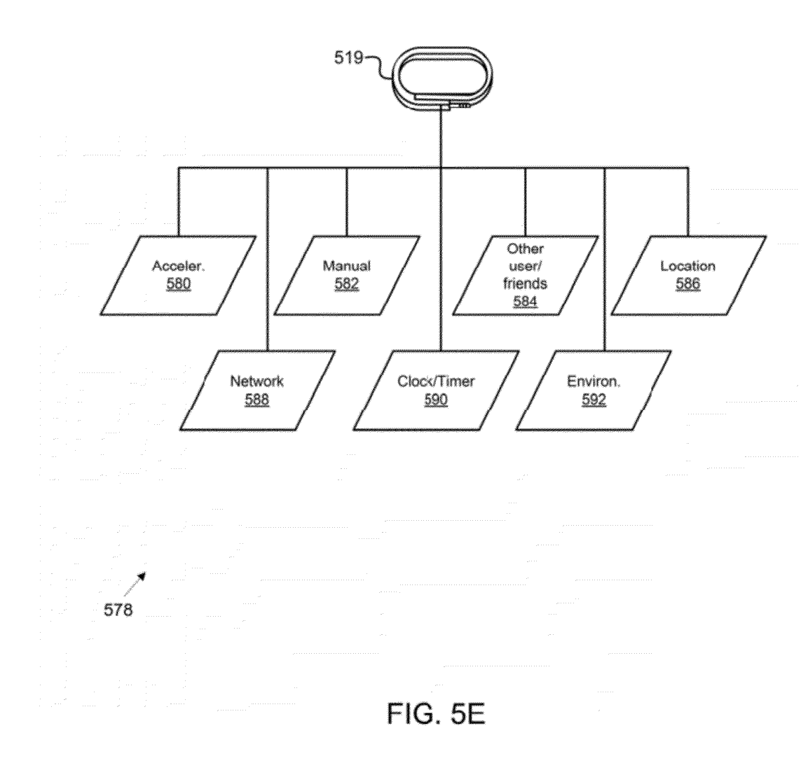

FIG. 5A illustrates representative data types for use with an exemplary data-capable band. Here, wearable device 502 may capture various types of data, including, but not limited to sensor data 504, manually-entered data 506, application data 508, location data 510, network data 512, system/operating data 514, and user data 516. Various types of data may be captured from sensors, such as those described above in connection with FIG. 3. Manually-entered data, in some examples, may be data or inputs received directly and locally by band 200 (FIG. 2). In other examples, manually-entered data may also be provided through a third-party website that stores the data in a database and may be synchronized from server 114 (FIG. 1) with one or more of bands 104-112. Other types of data that may be captured including application data 508 and system/operating data 514, which may be associated with firmware, software, or hardware installed or implemented on band 200. Further, location data 510 may be used by wearable device 502, as described above. User data 516, in some examples, may be data that include profile data, preferences, rules, or other information that has been previously entered by a given user of wearable device 502. Further, network data 512 may be data is captured by wearable device with regard to routing tables, data paths, network or access availability (e.g., wireless network access availability), and the like. Other types of data may be captured by wearable device 502 and are not limited to the examples shown and described. Additional context-specific examples of types of data captured by bands 104-112 (FIG. 1) are provided below.

FIG. 5B illustrates representative data types for use with an exemplary data-capable band in fitness-related activities. Here, band 519 may be configured to capture types (i.e., categories) of data such as heart rate/pulse monitoring data 520, blood oxygen saturation data 522, skin temperature data 524, salinity/emission/outgassing data 526, location/GPS data 528, environmental data 530, and accelerometer data 532. As an example, a runner may use or wear band 519 to obtain data associated with his . physiological condition (i.e., heart rate/pulse monitoring data 520, skin temperature, salinity/emission/outgassing data 526, among others), athletic efficiency (i.e., blood oxygen saturation data 522), and performance (i.e., location/GPS data 528 (e.g., distance or laps run), environmental data 530 (e.g., ambient temperature, humidity, pressure, and the like), accelerometer 532 (e.g., biomechanical information, including gait, stride, stride length, among others)). Other or different types of data may be captured by band 519, but the above-described examples are illustrative of some types of data that may be captured by band 519. Further, data captured may be uploaded to a website or online/networked destination for storage and other uses. For example, fitness-related data may be used by applications that are downloaded from a “fitness marketplace” or “wellness marketplace,” where athletes, or other users, may find, purchase, or download applications, products, information, etc., for various uses, as well as share information with other users. Some applications may be activity-specific and thus may be used to modify or alter the data capture capabilities of band 519 accordingly. For example, a fitness marketplace may be a website accessible by various types of mobile and non-mobile clients to locate applications for different exercise or fitness categories such as running, swimming, tennis, golf, baseball, football, fencing, and many others. When downloaded, applications from a fitness marketplace may also be used with user-specific accounts to manage the retrieved applications as well as usage with band 519, or to use the data to provide services such as online personal coaching or targeted advertisements. More, fewer, or different types of data may be captured for fitness-related activities.

In some examples, applications may be developed using various types of schema, including using a software development kit or providing requirements in a proprietary or open source software development regime. Applications may also be developed by using an application programming interface to an application marketplace in order for developers to design and build applications that can be downloaded on wearable devices (e.g., bands 104-106 (FIG. 1)). Alternatively, application can be developed for download and installation on devices that may be in data communication over a shared data link or network connection, wired or wireless. For example, an application may be downloaded onto mobile computing device 116 (FIG. 1) from server 114 (FIG.1), which may then be installed and executed using data gathered from one or more sensors on band 104. Analysis, evaluation, or other operations performed on data gathered by an application downloaded from server 114 may be presented (i.e., displayed) on a graphical user interface (e.g., a micro web browser, WAP web browser, Java/Java-script-based web browser, and others, without limitation) on mobile computing device 116 or any other type of client. Users may, in some examples, search, find, retrieve, download, purchase, or otherwise obtain applications for various types of purposes from an application marketplace. Applications may be configured for various types of purposes and categories, without limitation. Examples of types of purposes include running, swimming, trail running, diabetic management, dietary, weight management, sleep management, caloric burn rate tracking, activity tracking, and others, without limitation. Examples of categories of applications may include fitness, wellness, health, medical, and others, without limitation. In other examples, applications for distribution via a marketplace or other download website or source may be implemented differently and is not limited to those described.

FIG. 5C illustrates representative data types for use with an exemplary data-capable band in sleep management activities. Here, band 539 may be used for sleep management purposes to track various types of data, including heart rate monitoring data 540, motion sensor data 542, accelerometer data 544, skin resistivity data 546, user input data 548, clock data 550, and audio data 552. In some examples, heart rate monitor data 540 may be captured to evaluate rest, waking, or various states of sleep. Motion sensor data 542 and accelerometer data 544 may be used to determine whether a user of band 539 is experiencing a restful or fitful sleep. For example, some motion sensor data 542 may be captured by a light sensor that measures ambient or differential light patterns in order to determine whether a user is sleeping on her front, side, or back. Accelerometer data 544 may also be captured to determine whether a user is experiencing gentle or violent disruptions when sleeping, such as those often found in afflictions of sleep apnea or other sleep disorders. Further, skin resistivity data 546 may be captured to determine whether a user is ill (e.g., running a temperature, sweating, experiencing chills, clammy skin, and others). Still further, user input data may include data input by a user as to how and whether band 539 should trigger notification facility 208 (FIG. 2) to wake a user at a given time or whether to use a series of increasing or decreasing vibrations or audio tones to trigger a waking state. Clock data (550) may be used to measure the duration of sleep or a finite period of time in which a user is at rest. Audio data may also be captured to determine whether a user is snoring and, if so, the frequencies and amplitude therein may suggest physical conditions that a user may be interested in knowing (e.g., snoring, breathing interruptions, talking in one's sleep, and the like). More, fewer, or different types of data may be captured for sleep management-related activities.

FIG. 5D illustrates representative data types for use with an exemplary data-capable band in medical-related activities. Here, band 539 may also be configured for medical purposes and related-types of data such as heart rate monitoring data 560, respiratory monitoring data 562, body temperature data 564, blood sugar data 566, chemical protein/analysis data 568, patient medical records data 570, and healthcare professional (e.g., doctor, physician, registered nurse, physician's assistant, dentist, orthopedist, surgeon, and others) data 572. In some examples, data may be captured by. band 539 directly from wear by a user. For example, band 539 may be able to sample and analyze sweat through a salinity or moisture detector to identify whether any particular chemicals, proteins, hormones, or other organic or inorganic compounds are present, which can be analyzed by band 539 or communicated to server 114 to perform further analysis. If sent to server 114, further analyses may be performed by a hospital or other medical facility using data captured by band 539. In other examples, more, fewer, or different types of data may be captured for medical-related activities.

FIG. 5E illustrates representative data types for use with an exemplary data-capable band in social media/networking-related activities. Examples of social media/networking-related activities include activities related to Internet-based Social Networking Services (“SNS”), such as Facebook®, Twitter®, etc. Here, band 519, shown with an audio data plug, may be configured to capture data for use with various types of social media and networking-related services, websites, and activities. Accelerometer data 580, manual data 582, other user/friends data 584, location data 586, network data 588, clock/timer data 590, and environmental data 592 are examples of data that may be gathered and shared by, for example, uploading data from band 519 using, for example, an audio plug such as those described herein. As another example, accelerometer data 580 may be captured and shared with other users to share motion, activity, or other movement-oriented data. Manual data 582 may be data that a given user also wishes to share with other users. Likewise, other user/friends data 584 may be from other bands (not shown) that can be shared or aggregated with data captured by band 519. Location data 586 for band 519 may also be shared with other users. In other examples, a user may also enter manual data 582 to prevent other users or friends from receiving updated location data from band 519. Additionally, network data 588 and clock/timer data may be captured and shared with other users to indicate, for example, activities or events that a given user (i.e., wearing band 519) was engaged at certain locations. Further, if a user of band 519 has friends who are not geographically located in close or near proximity (e.g., the user of band 519 is located in San Francisco and her friend is located in Rome), environmental data can be captured by band 519 (e.g., weather, temperature, humidity, sunny or overcast (as interpreted from data captured by a light sensor and combined with captured data for humidity and temperature), among others). In other examples, more, fewer, or different types of data may be captured for medical-related activities.

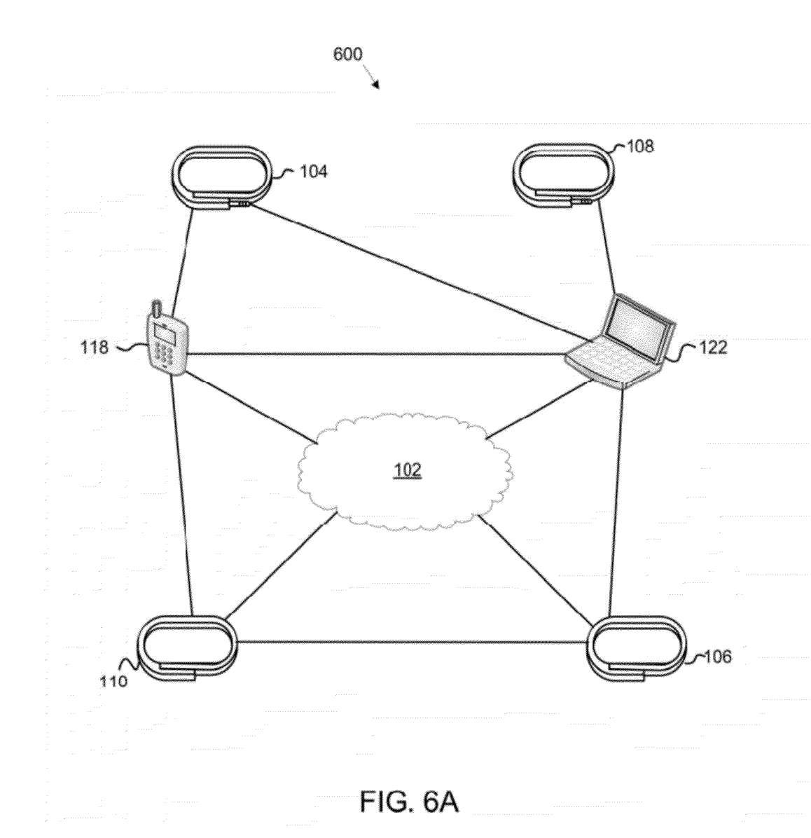

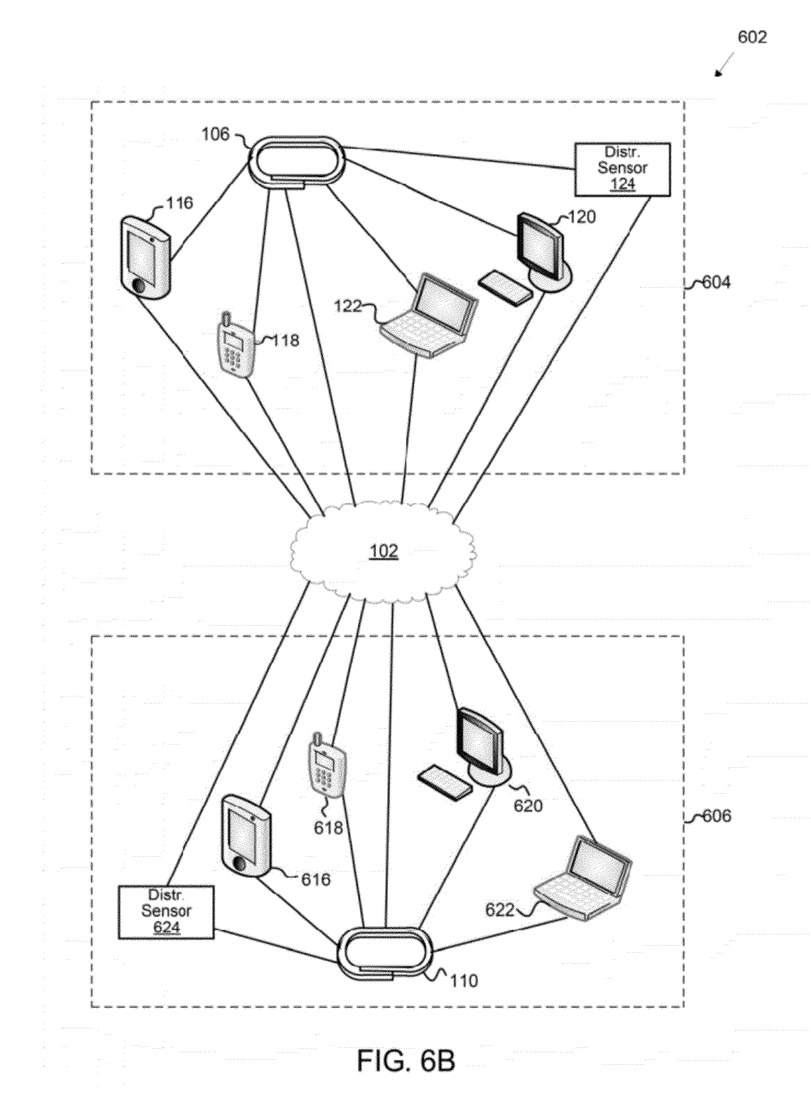

FIG. 6A illustrates an exemplary communications device system implemented with multiple exemplary data-capable bands. The exemplary system 600 shows exemplary lines of communication between some of the devices shown in FIG. 1, including network 102, bands 104-110, mobile communications device 118, and laptop 122. In FIG. 6A, examples of both peer-to-peer communication and peer-to-hub communication using bands 104-110 are shown. Using these avenues of communication, bands worn by multiple users or wearers (the term “wearer” is used herein to describe a user that is wearing one or more bands) may monitor and compare physical, emotional, mental states among wearers (e.g., physical competitions, sleep pattern comparisons, resting physical states, etc.).

Peer-to-hub communication may be exemplified by bands 104 and 108, each respectively communicating with mobile communications device 118 or laptop 122, exemplary hub devices. Bands 104 and 108 may communicate with mobile communications device 118 or laptop 122 using any number of known wired communication technologies (e.g., Universal Service Bus (USB) connections, TRS/TRRS connections, telephone networks, fiber-optic networks, cable networks, etc.). In some examples, bands 104 and 108 may be implemented as lower power or lower energy devices, in which case mobile communications device 118, laptop 122 or other hub devices may act as a gateway to route the data from bands 104 and 108 to software applications on the hub device, or to other devices. For example, mobile communications device 118 may comprise both wired and wireless communication capabilities, and thereby act as a hub to further communicate data received from band 104 to band 110, network 102 or laptop 122, among other devices. Mobile communications device 118 also may comprise software applications that interact with social or professional networking services (“SNS”) (e.g., Facebook®, Twitter®, LinkedIn®, etc.), for example via network 102, and thereby act also as a hub to further share data received from band 104 with other users of the SNS. Band 104 may communicate with laptop 122, which also may comprise both wired and wireless communication capabilities, and thereby act as a hub to further communicate data received from band 104 to, for example, network 102 or laptop 122, among other devices. Laptop 122 also may comprise software applications that interact with SNS, for example via network 102, and thereby act also as a hub to further share data received from band 104 with other users of the SNS. The software applications on mobile communications device 118 or laptop 122 or other hub devices may further process or analyze the data they receive from bands 104 and 108 in order to present to the wearer, or to other wearers or users of the SNS, useful information associated with the wearer's activities.

In other examples, bands 106 and 110 may also participate in peer-to-hub communications with exemplary hub devices such as mobile communications device 118 and laptop 122. Bands 106 and 110 may communicate with mobile communications device 118 and laptop 122 using any number of wireless communication technologies (e.g., local wireless network, near field communication, Bluetooth®, Bluetooth® low energy, ANT, etc.). Using wireless communication technologies, mobile communications device 118 and laptop 122 may be used as a hub or gateway device to communicate data captured by bands 106 and 110 with other devices, in the same way as described above with respect to bands 104 and 108. Mobile communications device 118 and laptop 122 also may be used as a hub or gateway device to further share data captured by bands 106 and 110 with SNS, in the same way as described above with respect to bands 104 and 108:

Peer-to-peer communication may be exemplified by bands 106 and 110, exemplary peer devices, communicating directly. Band 106 may communicate directly with band 110, and vice versa, using known wireless communication technologies, as described above. Peer-to-peer communication may also be exemplified by communications between bands 104 and 108 and bands 106 and 110 through a hub device, such as mobile communications device 118 or laptop 122.

Alternatively, exemplary system 600 may be implemented with any combination of communication capable devices, such as any of the devices depicted in FIG. 1, communicating with each other using any communication platform, including any of the platforms described above. Persons of ordinary skill in the art will appreciate that the examples of peer-to-hub communication provided herein, and shown in FIG. 6A, are only a small subset of the possible implementations of peer-to-hub communications involving the bands described herein.

FIG. 6B illustrates another exemplary communications device system implemented with multiple exemplary data-capable bands. Exemplary system 602 comprises two exemplary communication sub-systems 604 and 606. Exemplary sub-system 604 comprises communications capable devices, including distributed sensor 124, computer 120, laptop 122, mobile communications device 118 and mobile computing device 115, belonging to a user. Exemplary sub-system 606 comprises another set of communications capable devices, including mobile computing device 616, mobile communications device 618, computer 620, laptop 622, and distributed sensor 624, belonging to another user. The like-numbered devices in sub-system 604 may operate in the same manner as described above in relation to FIGS. 1 and 6A. The devices in sub-system 606 may operate in the same manner as the corresponding devices in sub-system 604. In some examples, these two users may share information their respective physical, mental and emotional states using their respective sub-systems 602 and 604 of devices. For example, band 106 may capture data associated with one user's activity, and share that data with any of the other devices in sub-system 604 (including distributed sensor 124, computer 120, laptop 122, mobile communications device 118 and mobile computing device 115). Each of those other devices in sub-system 604, as well as the band 106 itself, may share that data with devices in sub-system 606 via network 102. Thus, in this example, a user and another user may share data captured by their respective bands across long distances. Also in this example, a user and another user may share other information captured, or analyzed, by the other devices in each user's respective sub-systems of devices, to monitor each other's participation in addition to their own participation in an activity.

The peer-to-peer and peer-to-hub communications described above with respect to FIGS. 6A-6B may employ both push and pull technologies. Push technology refers to a style of communication where the request for a given communication transaction is initiated by the publisher. For example, as the publisher of the data it has captured, band 106 may push the data it has captured with regard to its wearer to band 110, whose wearer is co-participating in the activity. Band 106 may push this data to band 110 directly. Band 106 may also push this data indirectly through one or more hub devices. For example, band 106 may push the information to one or more of mobile computing device 115, mobile communications device 118, computer 120, laptop 122, and distributed sensor 124, which may in turn push the information to band 110, via network 102, and in some examples, via one or more of mobile computing device 616, mobile communications device 618, computer 620, laptop 622, and distributed sensor 624. Alternatively, pull technology also may be used. Pull technology refers to a style of communication where the request for a given communication transaction originates from the client device. For example band 110 may request information from one or more of network 102, mobile computing device 616, mobile communications device 618, computer 620, laptop 622, and distributed sensor 624, with regard to data from band 106.

In some examples, peer-to-peer and peer-to-hub communications may be used to monitor participation in a social activity in which two or more participants in the social activity wear one or more of bands 106-112. As described in more detail above, bands 102-112 may capture a wide range of data associated with a user's activities, using an array of sensors. This capability may be harnessed to share information associated with a user's participation in the social activity.

In some examples, bands 104-110 may each be implemented in conjunction with a health and fitness marketplace (examples of which are described above). In some examples, applications and information gleaned from a health and fitness marketplace may be used by bands 104-110, or other devices in exemplary systems 600-604, to monitor and manage a user's health and fitness. As described in more detail above, the user's bands may capture data associated with a user's exercise or overall health. The user's bands may also gather data from fitness machines or other devices that may also capture information associated with a user's exercise or overall health regimen. In some examples, using the information associated with a user's exercise regime and, overall health regimen from other equipment or devices, bands 104-112 may provide notifications to a user relating to the user's exercise or diet regimens (e.g., to prompt the user to check blood sugar, to eat a snack, or to exercise, etc.).

In other examples, systems 600-604 may be used to issue a challenge to a friend to compete in a physical activity. In one example, the challenger using, for example, band 106, and the friend using, for example, band 110, may be co-located and conducting the challenge in-person, in which case the challenger's band 106 may communicate directly with the friend's band 110. In some examples, the challenger and the friend each may wear more than one of bands 104-112 (e.g., one on each wrist, or one on a wrist and one on an ankle, etc.). Their bands may also communicate through hub devices that may comprise software designed to organize such challenges using data obtained from the bands. In another example, the challenger and the friend may be conducting the challenge remotely, either geographically or at different times (e.g., the challenger residing in one state or country challenges the friend residing in another state or country to see who can run the most miles in a single week). In such case, the challenger's bands may communicate with the friend's bands via one or more hub devices, for example, to push notifications to the friend when the challenger starts an activity that is part of the challenge, to push data to the friend relating to the activity, or to relay other information relating to the challenge.

Users may receive notifications, data or other information via hub devices (e.g., mobile computing device 616, mobile communications device 618, computer 620, laptop 622, and distributed sensor 624), as is well known. However, a user also may receive notifications, data or other information either using a display on one or more bands, or through audio or physical cues from one or more bands (e.g., beeps, vibrations or patterns of vibrations emanated from the band, verbal notifications, etc.). Because the band is a hands-free device (i.e., it is worn), delivery of content to a user through a band does not require the use of hands. Furthermore, when the content is delivered using audio or physical cues, then the user does not need to divert visual attention to the device, thereby leaving the user's hands and eyes free. This may be useful, for example, if a wearer is driving a car, and receives a notification that is pushed to the wearer's band, that notification may be provided through physical or audio cues, allowing the wearer to continue driving without taking their eyes off of the road or their hands off of the steering wheel.

In some examples, the information relating to the challenge may be shared using software applications. In some examples, this software may reside on any of bands 104-112 or on any of the hub devices 115-124 and 615-624 shown in FIGS. 6A-6B. The software applications may be capable of sharing information relating to the challenge with an SNS, thereby publishing the information to other users of the SNS. For example, a wearer may share directly, or indirectly through a hub device, information associated with a bike ride (e.g., distance, average speed, altitude climbed, etc.) on a Facebook® wall or in a tweet.

In addition to challenges, bands 104-112 may be used to play games among users. In some examples, bands 104-112 may be used by a user to customize a virtual representation of the user (e.g., an avatar, a game profile, etc.) to provide the virtual representation with characteristics associated with the user's real-life biometric or activity data. For example, a user's real-life biometric or activity data may be used to implement differences between users in virtual games that reflect the user's individual strengths and weaknesses (e.g., a user may have height advantages, a user may have various athletic advantages or disadvantages, a user may not need as much sleep as another user to operate or perform at a particular activity level, etc.), or otherwise handicap the game. In other examples, the games may be associated with real-world activities actually performed by users wearing data-capable bands (e.g., bands 104-112). For example, users may be able to use bands 104-112 to play popular games that would usually require physical proximity, but with bands 104-112 and the communications capabilities described herein, may be played among users that are remote in location or time. In other examples, given the capabilities of bands 104-112 as described herein, new games may be created for play using data-capable bands. In some examples, these games may be implemented using the various types of SNS described above. In other examples, these games may be separately implemented using various types of data and communications capable devices, in conjunction with data-capable bands.

In other examples, the users may not be competing and may be participating cooperatively in an activity. For example, a group of two or more users may run a marathon or cycle as a team together. Each user may wear one or more bands (e.g., bands 104-112) to capture data associated with their physical, emotional and mental states, as described in more detail above, and may share that data with other's in the group wearing bands. Their bands may communicate directly, or through hub devices, as described in detail above.

While various implementations of exemplary systems 600-604 have been described above, exemplary systems 600-604 may be implemented in different contexts not described herein, including with other communications capable devices not shown in FIGS. 6A-6B, and are not limited to the embodiments described above.

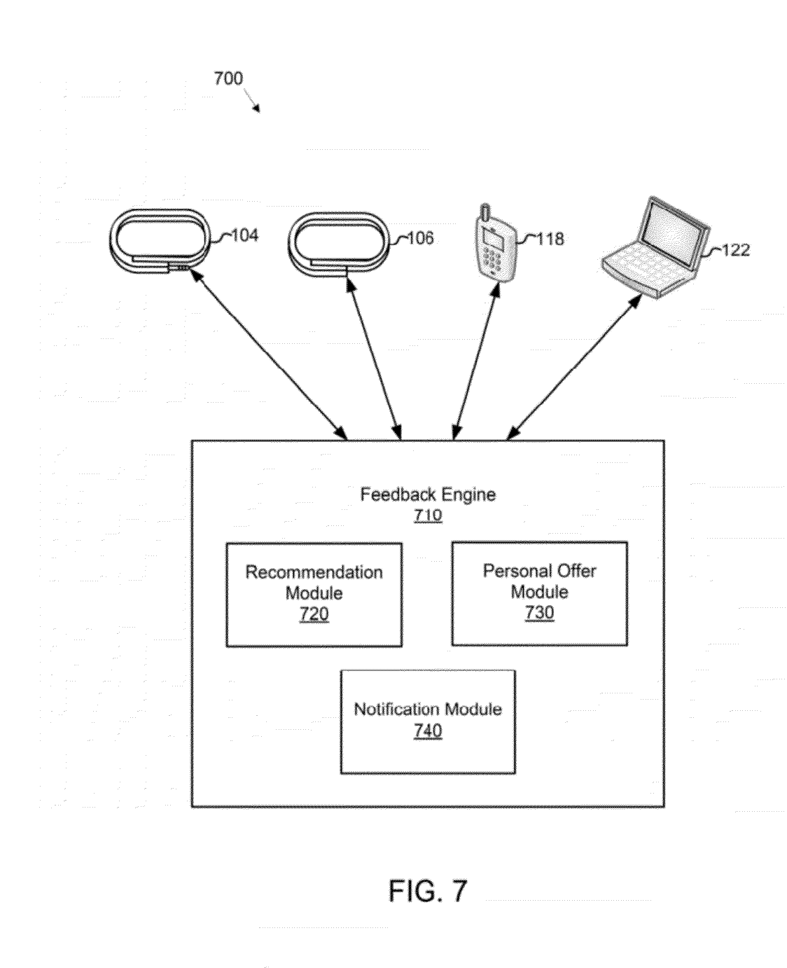

FIG. 7 illustrates an exemplary distributed personal advisor system implemented with multiple sensory, computing and communications devices, and a distributed application. In some examples, system 700 may include bands 104-106, mobile communications device 118, laptop 122, feedback engine 710, recommendation module 720, personal offer module 730, and notification module 740. Bands 104-106, mobile communications device 118 and laptop 122 may be implemented as described above. Feedback engine 710 may receive sensory and other data associated with a user's activities (“activity data”) from various source devices, including, for example, bands 104-106, mobile communications device 118, laptop 122, any of the other data and communications capable devices described herein, or other sources. In addition to sensory data gathered from bands 104-106, in some examples, additional information may be provided (e.g., via mobile communications device 118 and laptop 122) regarding, e.g., how a user feels after an activity or responds to an activity, to provide even richer data to the personal advisor system and the feedback engine. In some examples, feedback engine 710 may perform various types of analysis on the activity data received (e g., determining an activity type, determining environmental factors associated with the activity (e.g., geography, location, weather, time of day, day of week, season, etc.), determining the level of activity, etc.). In some examples, feedback engine 710 may be implemented with recommendation module 720, which may be configured to generate wellness recommendations associated with the activity data. Wellness recommendations may comprise recommendations associated with food, exercise, rest, sleep, entertainment, shopping, clothing, accessories, and other activities, products or services associated with the user's wellness. For example, if the activity data showed that a user performed vigorous exercise, expending a lot of water, calories and/or electrolytes, recommendation module 720 may generate wellness recommendations associated with replenishing the user's water, calories and/or electrolytes (e.g., a sports drink, a food item, a meal type, etc.). In other examples, wellness recommendations may be directed to an action (e.g., a yoga pose, a stretch, or other exercise, in response to activity data indicating the user has been sitting in the same position for an extended period of time, etc.), a product (e.g., a baseball glove, knee brace, type or model of sunglasses, type or model chair, style of exercise clothing, etc.), or a service (e.g., masseuse, acupuncturist, trainer, nutritionist, sleep therapist, etc.). In some examples, recommendation module 720 may be implemented as part of feedback engine 710, as shown. In other examples, recommendation module 720 may be implemented separately from feedback engine 710 (not shown).

In some examples, feedback engine 710 may be implemented with personal offer module 730, which may be configured to generate personal wellness offers associated with the activity data. Personal wellness offers may comprise coupons, other discounts, service try-outs (e.g., free introductory services and consultations), or other deals or offers associated with the user's wellness. In some examples, personal offer module 730 may generate personal wellness offers using a variety of advertising models. In other examples, personal offer module 730 may generate personal wellness offers in association with a wellness marketplace, as described herein. In some examples, personal offer module 730 may be implemented as part of feedback engine 710, as shown. In other examples, personal offer module 730 may be implemented separately from feedback engine 710 (not shown).

In some examples, the wellness recommendations and personal wellness offers may account for a user's history of activity data, including environmental data. In other examples, the wellness recommendations and personal wellness offers also may account for a user's medical history, which may be determined from data gathered using data-capable bands (e.g., bands 104-106), or may be input using other source devices. Such information may be stored in a database or other repository accessible by feedback engine 710, and may be implemented with or within the personal advisor system. For example, if a user has a medical condition (e.g., diabetes, high cholesterol, heart disease, arthritis, food allergies, etc.), recommendation module 720 and personal offer module 730 may tailor wellness recommendations or personal wellness offers, respectively, to the user's unique medical history.

In some examples, feedback engine 710 may be implemented with notification module 740, which may be configured to generate a feedback notification comprising a wellness recommendation or a personal wellness offer. In some examples, the feedback notification may include both a wellness recommendation and a personal wellness offer. In other examples, the feedback notification may include multiple wellness recommendations and/or multiple personal wellness offers. In some examples, feedback engine 710 may be configured to provide feedback notifications to non-source devices, wherein the activity data was received from one or more source device. For example, feedback engine 710 may receive activity data from a user's bands 104-106, and using notification module 740, generate and send a feedback notification to the user's mobile communications device 118 or laptop 122. In some examples, this feedback notification may be delivered directly using an application that is part of the personal advisor system. In other examples, it may be delivered in a manner such that the user may access it via a wellness marketplace. In some examples, notification module 740 may generate different types of feedback notification for providing to different types of devices to which the feedback notification may be sent.

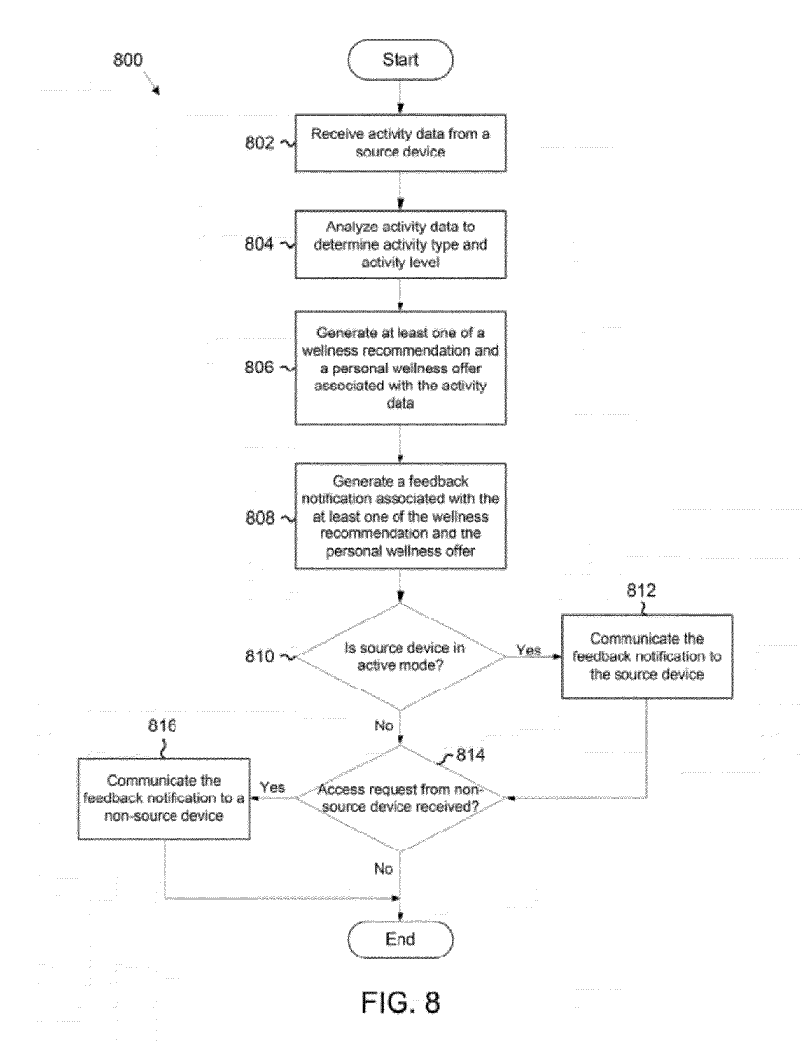

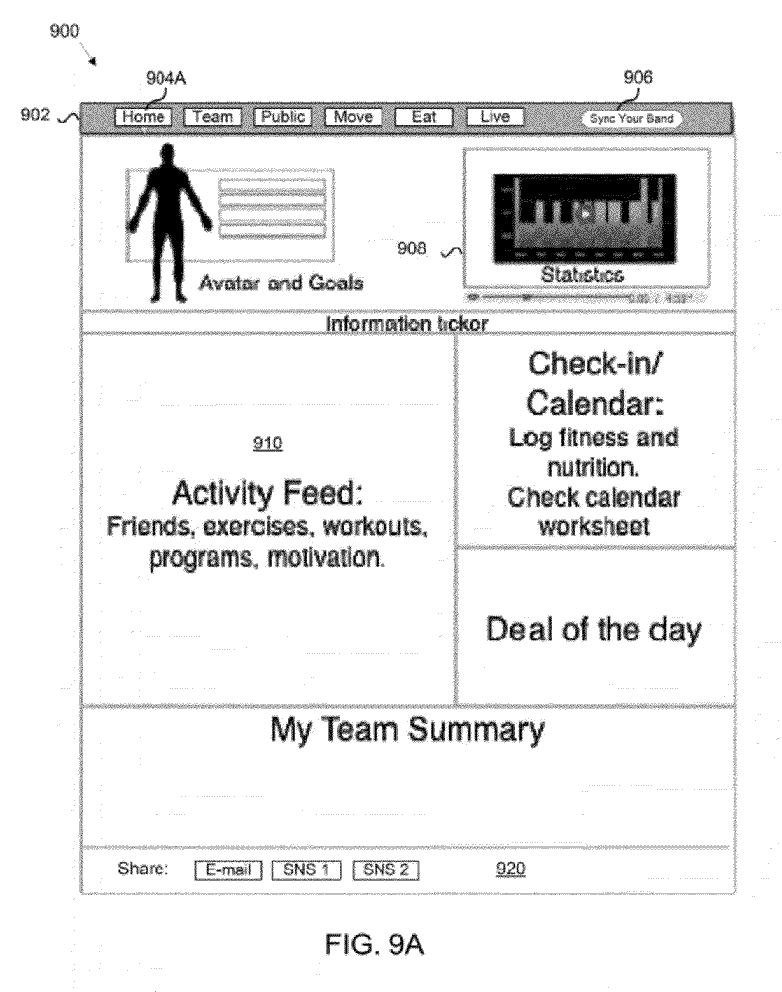

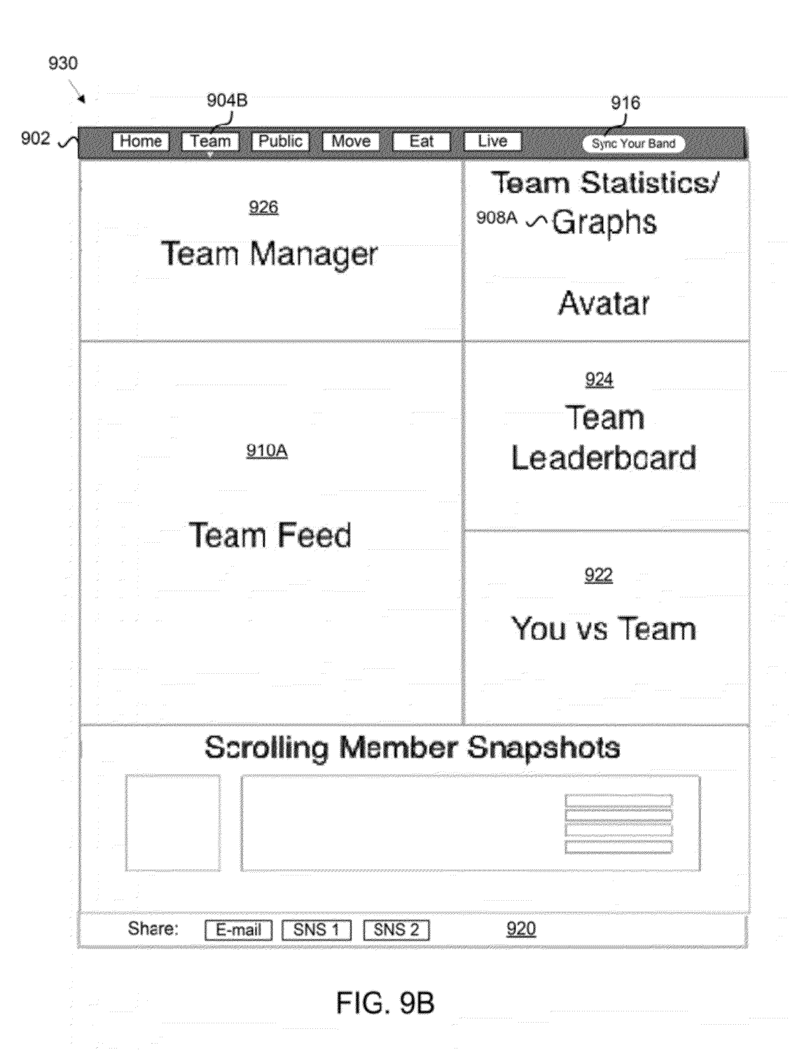

FIG. 8 illustrates an exemplary process for providing feedback notifications based upon activity data. Process 800 may be implemented as an exemplary process for generating feedback notifications associated with a user's activity data, and providing the feedback to either a source or non-source device. In some examples, process 800 may begin with receiving activity data from a source device (802). A source device may comprise one or more of the data-capable bands described herein (e.g., bands 104-106). In another example, a source device may comprise another type of data and communications capable devices, such as those described above (e.g., mobile communications device 118, laptop 122, etc.), which may enable a user to provide activity data via various inputs (e.g., typing, uploading, etc.). After receiving activity data, the activity data may be analyzed to determine, e.g., an activity type, an activity level, or other information, including environmental information associated with the user's activity (804). Once analyzed, the activity data may be used to generate at least one of a wellness recommendation and a personal wellness offer (806), after which a feedback notification may be generated that is associated with at least one of the wellness recommendation and the personal wellness offer (808). Once the feedback notification is generated, a determination may be made whether the source device is in an active mode (e.g., on, available for receiving data, etc.) (810). When a determination is made that the source device is in an active mode, the feedback notification may be communicated to the source device (812). After the feedback notification may be communicated to the source device, or when a determination is made that the source device is not in an active mode, another determination is made whether an access request has been received from a non-source device (814). For example, the user may be accessing the personal advisor system using a non-source device (e.g., mobile communications device 118, laptop 122, or other device). If it is determined that an access request has been received from a non-source device, the feedback notification may be communicated to the non-source device (816). In some examples, the feedback notifications may be pushed to the source device or the non-source device (e.g., automatically pushed to a feed on a user's personal advisor webpage (FIG. 9A)). In such a case, a determination may not need to be made as to whether an access request was received from a non-source device. In other examples, the above-described process may be varied in the implementation, order, function, or structure of each or all steps and is not limited to those provided.

FIGS. 9A-9B illustrate exemplary wireframes of exemplary webpages including features that may be used in a personal advisor system. Here, wireframe 900 comprises navigation 902, selected page 904A, sync widget 906, statistics clement 908, social feed 910, and share element 920. An exemplary webpage may include fewer, or more, features that may be used in a personal advisor system. In some examples, a personal advisor system may include, or be used in conjunction with, a wellness marketplace, which may be implemented as a portal, website or application where users, may find, purchase, or download applications, products, information, etc., for various uses, as well as share information with other users (e.g., users with like interests). Here, navigation 902 comprises buttons and widgets for navigating through various pages of the website, including the selected page 904A-904B (e.g., the Home page, Team page, etc.) and sync widget 906. In some examples, sync widget 906 may be implemented to sync a data-capable band to the user's account with a wellness marketplace, a personal advisor system, or both. In some examples, the webpage may include statistics element 908, which may be implemented to display statistics associated with the user's wellness (e.g., the graphical representations described above). As shown here, in some examples, statistics element 908 may be implemented as a dynamic graphical, and even navigable, element (e.g., a video or interactive graphic), wherein a user may view the user's wellness progress over time. In other examples, the statistics element 908 may be implemented differently. The webpage may further include social feed 912, which may be implemented as a scrolling list of messages or information (e.g., encouragement, news, feedback, recommendations, comments, etc.) from friends, advisors, coaches, or other users. The messages or information may include auto-generated encouragement, comments, news, recommendations, feedback, achievements, opinions, actions taken by teammates, wellness recommendations, personal wellness offers, or other information, by a wellness application in response to data associated with the user's wellness and activities (e.g., gathered by a data-capable band). In some examples, social feed 912 may be searchable. In some examples, social feed 912 may enable a user to filter or select the types of messages or information that shows up in the feed (e.g., from the public, only from the team, only from the user, etc.). Social feed 912 also may be configured to enable a user to select an action associated with each feed message (e.g., cheer, follow, gift, etc.). In some examples, a user may access wellness recommendations and personal wellness offers using other widgets or elements on a webpage. In some examples, the webpage may be implemented with a share element 920, configured to enable a user to share information associated with their wellness, including their wellness recommendations and personal wellness offers, with other users (e.g., friends, acquaintances, users with shared interests, etc.). In some examples, share element 920 may be implemented with various options for sharing information, including e-mail and various SNS, as described herein. A webpage for use in conjunction with a personal advisor system may be implemented differently than described here.

Wireframe 930 comprises another exemplary webpage, which may include a navigation 902, selected page 904B, sync widget 906, comparison element 922, leaderboard element 924, team manager element 926, statistics element 1208A, social feed 912A, and share element 920. Statistics element 908A, navigation 902, selected page 904B and sync widget 906 may be implemented as described above with regard to like-numbered or corresponding elements. In some examples, team manager element 926 may be implemented as an area for displaying information, or providing widgets, associated with the management of a team. As used herein, the term “team” may refer to any group of users of data-capable bands that elect to participate in an activity together. In some examples, a user may be part of more than one team. In other examples, a group of users may form different teams for different activities, or they may form a single team that participates in, tracks, and shares information regarding, more than one activity. Access to team manager element 928 may be restricted, in some examples, or access may be provided to the entire team. Leaderboard element 924 may be implemented to display leaders in various aspects of an activity in which the team is participating (e.g., various sports, social functions (e.g., clubs), drinking abstinence, etc.). In some examples, leaderboard element 924 may be implemented to display leaders among various groupings (e.g., site-wide, team only, other users determined to be “like” the user according to certain criteria (e.g., similar activities), etc.). In other examples, leaderboard element 924 may be organized or filtered by various parameters (e.g., date, demographics, geography, activity level, etc.). Comparison element 922 may be implemented, in some examples, to provide comparisons regarding a user's performance with respect to an activity, or various aspects of an activity, with the performance of the user's teammates or with the team as a whole (e.g., team average, team median, team favorites, etc.). Other elements may be implemented on a webpage for monitoring, tracking, or displaying other information, associated with challenges and other competitions among users. A team webpage may be implemented differently than described here.

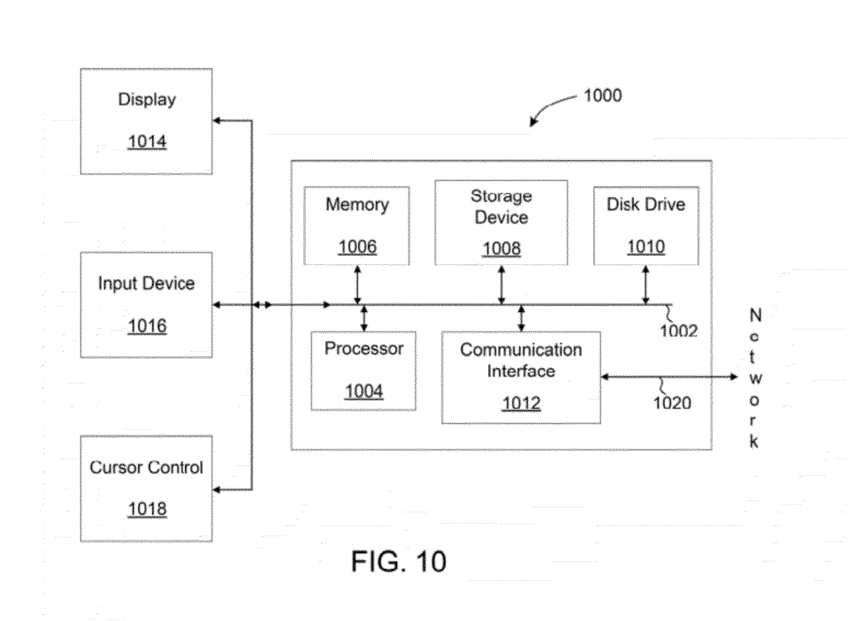

FIG. 10 illustrates an exemplary computer system suitable for use with a data-capable band. In some examples, computer system 1000 may be used to implement computer programs, applications, methods, processes, or other software to perform the above-described techniques. Computer system 1000 includes a bus 1002 or other communication mechanism for communicating information, which interconnects subsystems'and devices, such as processor 1004, system memory 1006 (e.g., RAM), storage device 1008 (e.g., ROM), disk drive 1010 (e.g., magnetic or optical), communication interface 1012 (e.g., modem or Ethernet card), display 1014 (e.g., CRT or LCD), input device 1016 (e.g., keyboard), and cursor control 1018 (e.g., mouse or trackball).

According to some examples, computer system 1000 performs specific operations by processor 1004 executing one or more sequences of one or more instructions stored in system memory 1006. Such instructions may be read into system memory 1006 from another computer readable medium, such as static storage device 1008 or disk drive 1010. In some examples, hard-wired circuitry may be used in place of or in combination with software instructions for implementation.

The term “computer readable medium” refers to any tangible medium that participates in providing instructions to processor 1004 for execution. Such a medium may take many forms, including but not limited to, non-volatile media and volatile media. Non-volatile media includes, for example, optical or magnetic disks, such as disk drive 1010. Volatile media includes dynamic memory, such as system memory 1006.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1002 for transmitting a computer data signal.

In some examples, execution of the sequences of instructions may be performed by a single computer system 1000. According to some examples, two or more computer systems 1000 coupled by communication link 1020 (e.g., LAN, PSTN, or wireless network) may perform the sequence of instructions in coordination with one another. Computer system 1000 may transmit and receive messages, data, and instructions, including program, i.e., application code, through communication link 1020 and communication interface 1012. Received program code may be executed by processor 1004 as it is received, and/or stored in disk drive 1010, or other non-volatile storage for later execution.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A personal advisor distributed application, comprising:
a feedback engine configured to process user activity data from a source device, the source device comprising at least one data-capable band;
a recommendation module configured to generate a wellness recommendation using the user activity data;
a personal offer module configured to generate a personal wellness offer using the user activity data; and
a notification module configured to generate a feedback notification comprising one or more of the wellness recommendation and the personal wellness offer,
wherein the feedback engine is operable to communicate the feedback notification to the source device.

2. The personal advisor application of claim 1, wherein the source device further comprises a plurality of data-capable bands.

3. The personal advisor application of claim 1, wherein the source device further comprises a communications capable device configured to enable manual entry of the user activity data.

4. The personal advisor application of claim 1, wherein the feedback engine further is operable to communicate the feedback notification to a non-source device.

5. The personal advisor application of claim 1, wherein the feedback engine is operable to accumulate the user activity data over a time period.

6. The personal advisor application of claim 5, wherein the recommendation module generates the wellness recommendation using the user activity data accumulated over the time period.

7. The personal advisor application of claim 5, wherein the advertising module generates the personal wellness offer using the user activity data accumulated over the time period.

8. The personal advisor application of claim 1, wherein the personal wellness offer is a coupon:

9. The personal advisor application of claim 8, wherein the coupon is operable to be redeemed using the source device.

10. The personal advisor application of claim 8, wherein the coupon is operable to be redeemed using a non-source device.

11. The personal advisor application of claim 10, wherein the non-source device is a mobile communication device operable to display the coupon.

12. The personal advisor application of claim 1, wherein the feedback notification is based on a determination of a mood.

13. The personal advisor application of claim 1, wherein the feedback notification is based on a determination of a medical condition.

14. The personal advisor application of claim 1, wherein the feedback notification is based on a determination of a user activity.

15. The personal advisor application of claim 1, wherein the feedback notification is based on a determination of a physiological ailment.

16. The personal advisor application of claim 1, wherein the feedback notification is based on a determination of a physical ailment.

17. The personal advisor application of claim 1, wherein the feedback notification is associated with nutrition.

18. The personal advisor application of claim 1, wherein the feedback notification is associated with exercise.

19. A method, comprising:
receiving activity data from a source device;
processing the activity data to generate a feedback notification associated with at least one of a wellness recommendation and a personal wellness offer; and
communicating the feedback notification to the source device when the source device is in an active mode.

20. The method of claim 19, further comprising communicating the feedback notification to a non-source device in response to a request from the non-source device to access the personal coaching application.

21. A computer readable medium including instructions for performing a method, the method comprising:
receiving activity data from a source device;
processing the activity data to generate a feedback notification associated with at least one of a wellness recommendation and a personal wellness offer; and
communicating the feedback notification to the source device when the source device is in an active mode.
